(19) United States
(12) Patent Application Publication
(10) Pub. No.: US 2024/0240471 A1
(43) Pub. Date: Jul. 18, 2024

(54) STUDDED MEMBRANE FOR UNDERFLOOR HEATING, WITH ADHESIVE CURB

(71) Applicant: TEMA TECHNOLOGIES AND MATERIALS SRL, Vittorio Veneto (TV) (IT)

(72) Inventors: Federico CAIS, San Vendemiano (TV) (IT); Nicola BUSATTA, Conegliano (TV) (IT); Giovanni VIEL, Sacile (PN) (IT)

(21) Appl. No.: 18/559,241

(22) PCT Filed: May 3, 2022
(86) PCT No.: PCT/IB2022/054060

§ 371 Date: Nov. 6, 2023

(30) Foreign Application Priority Data
May 7, 2021 (IT) 102021000011699

(51) Int. Cl. E04F 15/18; B32B 3/20; B32B 3/30; B32B 5/02; B32B 7/14; B32B 15/08; B32B 15/14; B32B 15/20; B32B 27/08; B32B 27/12; B32B 27/30; B32B 27/32; F24D 3/14; F24D 13/02

(52) U.S. Cl. CPC E04F 15/185; B32B 3/20; B32B 3/30; B32B 5/022; B32B 7/14; B32B 15/08; B32B 15/14; B32B 15/20; B32B 27/08; B32B 27/12; B32B 27/306; B32B 27/32; F24D 3/141; F24D 13/024; B32B 2270/00; B32B 2274/00; B32B 2307/304; B32B 2307/4026; B32B 2307/7376; B32B 2419/00

(57) ABSTRACT

Disclosed is a studded membrane for underfloor heating, of the detaching membrane type which also acts as a support for the laying of electrical conductors. The studded membrane has one waterproof plastic sheet coupled to one base layer for anchoring the membrane on the laying plane, with studs which protrude from the membrane-plane and are arranged in a matrix with regular center to center distance in such a way to obtain hollow and continuous spaces among them in the form of corridors. A heating cable is retained and placed among the studs. In particular, adhesive curbs are provided to retain the heating cable and are made up of a glue laid in strips on the membrane-plane, in correspondence with the corridors among the studs acting as laying corridors for the glue.

### FIELD OF THE INVENTION

The present invention relates to a studded membrane for underfloor heating, provided with adhesive curb.

### BACKGROUND OF THE INVENTION

The invention is specifically intended for the building industry and particularly in the sector of semi-finished components for construction. In particular, reference is made to the thin membranes provided with studs which are simultaneously used to separate the foundation screed from the floor and to house the heating cable of a modem low-thickness electric heating. More generally, the proposed solution is advantageous in all cases of underfloor heating where the heating elements are in continuous linear form and with low thickness, as in the case of said electrical energy heating cables or also in the case of thin hot fluid pipes.

Today, different types of membranes are widespread in the construction sector, having various purposes: for example, mention is made of vapor membranes, bituminous waterproofing membranes, drainage membranes, geomembranes or also non-woven fabric separation sheets. In particular, in modem building practice waterproof membranes are widely known, which are widely applied by the installers of ceramic coatings, of marble slabs or in any case of fragile type coatings, in order to avoid cracking and detachment; these problems sometimes indeed occur in the case of differentiated thermal expansion between the layers, or for the movements of the floor, for the micro-settlements of the foundation or for any deformation of the support plane which is not correctly supported by the covering layer. A membrane suitable for avoiding such problems is conventionally called a detaching membrane, or a decoupling membrane or a coupling, or also separating sheet being interposed in the form of a diaphragm between the supporting structure and said coating to prevent adhesion, dissipate the tensions and/or absorb deformations. To this end, the waterproofing membranes of the studded type are particularly effective, which separate the layers to a greater extent, distribute the punctual loads uniformly and also compensate for the vapor tensions of the foundation.

It has also been found, in professional practice, that the solutions most used today involve waterproof membranes of the studded type, used as such or coupled to a permeable layer of fabric. More in detail, sheets with small studs are widely used, which studs are obtained in surface continuity, like cylindrical, truncated cone or truncated pyramidal protrusions arranged in a regular matrix, being suitable for increasing the distance between the layers, and also suitable for improving stability and adhesion, they allow the cement adhesive which contacts said sheet to penetrate into the interstices between the studs or into the cavities inside the protrusions themselves, depending on the direction of positioning.

By way of mere example, single-layer studded sheets are used in underground constructions, as an element of external protection and waterproofing from the ground, and also in said cases of ceramic flooring on floors made of reinforced concrete, of wood or in the screeds on the ground floor. For some applications, however, for example for a more effective drainage or to increase said detaching function, the studded sheet is also coupled to a base layer made of permeable fabric such as a non-woven fabric or TNT, of polypropylene, of the type called spunbonded or spunlace. In particular, in the detaching use on a reinforced concrete screed, it is known that such a base layer adheres well to the underlying adhesive penetrating into it and also helps to compensate for the different movements between said screed and the flooring above the studded sheet.

The raw materials most suitable for this type of working are the resins of the type called olefins, and in particular polyethylene, which can be of low density, medium density or also of high density, being respectively called LDPE, MDPE and HDPE; alternatively, polypropylene is suitable, known by the acronym PP, or thermoplastic polyolefins, known by the acronym TPO. In some cases, polystyrene is also used, known by the acronym PS. These raw materials can be virgin or regenerated, the latter being derived from the recovery of the products in the post production or post-use phase.

Recently, in the building sector, there has also been a remarkable diffusion of innovative low-thickness heating technologies, being integrated between the floor screed and the flooring, and conventionally referred to as underfloor heating. In principle, they include a thin and continuous heating means shaped like a cable or pipe, which is placed on a studded membrane of the abovementioned detaching type which thus performs the separation functions described above advantageously combined with the specific functions of housing and positioning of the heating means, be it a modem heating cable with electric resistances or the traditional channeling of a hot fluid. Alternatively, solutions are known of insulating panels which are shaped in such a way as to house said heating elements; these solutions integrate the insulation function but do not give the benefits offered by a detaching studded plastic membrane, besides having a high cost. The present invention proposes an innovative studded plastic membrane, which has all the advantages of the known detaching membranes and also solves the main problems an installer has in positioning a heating cable, considerably facilitating the professional activity as described below.

In particular, installers are well aware of the difficulty of retaining and/or blocking the heating element in the correct position during construction site work, since it is positioned along an outward-and-retum path with parallel and spaced segments according to a project, so as to progressively cover the entire surface of the floor considering the localized heat transfer and/or accumulation capacity of the various construction elements involved. More in technical detail, there are considerable difficulties in laying a heating cable with electric resistances since it has a very small diameter, generally between 2 mm and 6 mm, and is non-deformable in the transversal direction or in section but deformable in the lengthwise direction, like a common electric cable.

These characteristics make a heating cable difficult to maintain in the intended position, during the laying phase, where the path is continuous, well defined and tens of meters long. In such cases, it is therefore advantageous to use a detaching membrane made of plastics with said studs facing upwards, where it is possible to use the spaces between these protrusions as a guided housing for laying the heating cable. Said studs thus have a height greater than or equal to the diameter of said cable and have a conformation which can facilitate both its positioning and its maintenance along articulated paths.

More in detail, the practical advantages are well known to the professional operators deriving from the use of a studded membrane made of plastic suitable for simultaneously separating the screed, housing said heating cable and also retaining it in position at least until the casting of the concrete topping and/or the laying of the floor above. To this end, the companies operating in the building sector have proposed numerous solutions of detaching membranes with integrated retaining means: in principle, the solution which is considered more advantageous is to provide the individual studs with lateral protrusions and/or undercuts such that, being two studs placed side by side at a specific distance from each other, they act reciprocally as retaining elements for the cable which is interposed between them. By way of mere example, one of the most popular products on the market of such concepts is the membrane marketed under the name Ditra-Heat, by the German company Schliiter-Systems KG-Iserlohn www.schlueter.de, formed by a studded membrane made of polypropylene coupled to a lower layer made of TNT, which has the lateral walls of the studs inclined in such a way as to form dovetail pinches suitable for housing and retaining a heating cable inserted between them.

In particular, in order to act as a means for retaining the heating cable, in these detaching membranes there is a slight interference of insertion between the studs being shaped with said lateral protrusions and/or undercuts and/or reciprocally dovetail inclined walls, where the diameter of the cable is exactly equal and/or slightly greater than their minimum distance. This solution, however, involves a serious problem of low versatility of application, said membrane being constrained to a specific cable diameter, with multiple disadvantages for the installer in terms of management and execution, of storage and transport of diversified membranes, scraps and/or unused portions and also with higher overall costs. Furthermore, it has been found that this solution requires extreme precision and care in the realization of the studs and also in the conservation of the finished product in order to ensure said interference in all environmental and/or laying conditions; it may indeed happen that the tolerances allowed in said minimum distance between the studs are not respected due to high temperatures and/or excessive deformations in the storage or transport phase.

Alternatively, membranes for heating cables are known with punctual retaining elements, such as hooks or blocking means added to a conventional membrane at the points where the cable must be retained. However, these solutions are not as much appreciated by installers since they are less easy and less quick to lay and involve higher overall costs than the abovementioned membranes provided with shaped studs which also act as cable retention means.

It is therefore technically preferable and desirable to have a studded membrane made of plastic of the detaching type, simple and economical to produce, which integrates an innovative and effective solution for retaining the heating cable, capable of overcoming the abovementioned problem of versatility and, that is, which does not constrain the membrane to a single cable diameter, facilitating the work of the operator and the management of construction site materials.

### STATE OF THE ART

In order to determine the state of the art related to the proposed solution, a conventional verification has been carried out, examining public archives, which has led to the identification of some prior art documents, among which the following:
D1: U.S. Pat. No. 8,176,694 (Batori)
D2: WO2018207082 (E. Roderick et al.)
D3: EP3183505 (Larson)
D4: WO2017025462 (Bordin)
D5: US2009230113 A1 (Batori)
D6: GB2457132 A (Thermonet System)
D7: U.S. Pat. No. 8,476,359 B2 (Wang Baoyu)
D8: US2018223543 5 A1 (Faotto)

D1 and D5 describe a detaching membrane for separating the screed from the floor acting as a support for the heating cable of an underfloor heating, facilitating the laying operations. It is a flexible plastic sheet provided with upward protrusions which are variously shaped and coupled in such a way as to form multiple housing seats for a flexible heating cable, aligned along laying paths, where said cable can be snapped in and retained like a mechanical constraint thanks to the interference reciprocally exerted by the protrusions.

D2 proposes a separating membrane which comprises protrusions suitable for retaining flexible conditioning elements, which define between their side walls a plurality of paths for said elements, with rectilinear segments and wavy segments which are defined by two or more protrusions spaced apart by a predetermined distance, being arranged in pairs aligned according to lines which intersect the path obliquely in such a way that the conditioning element is retained by elastic-mechanical contrast with the lateral walls of the protrusions.

D3 describes a membrane provided with protrusions shaped in such a way as to contain and retain a flexible heating element, such as a heating cable, inside a housing seat obtained therein; the particular arrangement of the protrusions allows the installer to position said cable according to a determined path, with various angles and folds.

D4 proposes a supporting membrane for heating elements of radiant floors and coverings, comprising a studded sheet where the protrusions are arranged in a matrix and define spaces between them for the laying of piping or electric heating cables. In particular, said studs or protrusions have perimeter walls with anti-extraction shape, for the interlocking insertion of a heating element in the space between two near studs, with a further blocking element interlocked between the perimeter walls of opposite studs. These and other objects and advantages of the present invention will become apparent from a reading of the attached specification and appended claims.

### Drawbacks

Ultimately, it has been noted that the described known solutions have drawbacks or in any case limitations.

In a first place, in all the known solutions described above, being inclusive of mechanical retaining means integrated in the conformation of the studs, the diameter of the conductor cable is directly correlated to a specific type of detaching membrane suitable for supporting an electrical conductor. More in dimensional detail, it is noted that the height of the protrusions or studs of the membrane has to coincide or to be slightly greater than the diameter of the heating cable, while the distance between two protrusions placed side by side has to coincide or to be slightly shorter than the diameter itself, so that it can mechanically engage with an interlocking action. During installation, it is indeed necessary for the cable to remain well interlocked between said protrusions in order to remain stationary also during the subsequent phase of laying of the floor, which generally consists in applying a layer of cement adhesive and ceramic tiles placed above as an external finish. Consequently, the known solutions according to D1-D5 and D8 are not very versatile since they are compatible with a predefined type of electrical conductor, characterized by a given size and shape; basically, a membrane conceived in this way is not suitable for laying heating cables having a diameter other than the predefined one, heavily limiting the activity of installers and designers, with disadvantages in the practical activity and also in the management of materials.

In a second place, in the known solutions it has been found that each further element added in order to locally block the heating element, as for example in D4, involves an increase in time and costs for the installer and also inconvenience in the management of materials. It is also known that artisan laying solutions without a shaped membrane provided with cable housings, using a double-sided adhesive tape directly applied to the floor as in D6, do not ensure uniformity of positioning and of action of the heating cable, and do not facilitate the practical activity of the operator either; furthermore, a removable protective layer is necessary which must be repositioned after the cable has been applied, avoiding trampling on and damaging the system as sometimes happens in the setting and/or repositioning phases.

In a third place, in the known solutions where the plastic sheet has studs with inclined walls and/or integrated engaging pieces of said heating cable, it has been found that the production procedure for obtaining them is not easy and involves longer and more complex working cycles compared to normal sheets with studs having a regular conformation and without undercuts, resulting in greater waste and also in greater investment in equipment.

In a fourth place, in the known solutions it has been found that the particular construction conformation of said protrusions or studs allows the heating cable to be retained by means of interlocking and/or interference, but it also contributes to increase the tear resistance of the layers composing the floor. More specifically, tear resistance is generally considered as tensile strength perpendicular to the plane of a layered package comprising a cement base or screed, a first layer of glue or cement mortar, said studded membrane, a further superimposed layer of glue or cement mortar and a final finishing layer of ceramic tiles. In the known solutions, the cement mortar penetrates into the cavities between the protrusions, such as channels and/or interstices opened from above, and also penetrates from below into the protrusions themselves, where said means for retaining the heating cable also improve the grip of said mortar; by using instead a conventional membrane where the studs have a regular conformation or are without such mechanical means for retaining the cable, said contribution to said tear resistance would be also lost.

Consequently there is the need for companies in the sector to identify solutions which are more effective than the solutions currently available; an aim of the present invention is also to obviate the drawbacks described.

### BRIEF SUMMARY OF THE INVENTION

This and other aims are achieved with the present invention according to the characteristics referred to in the attached claims, solving the problems set forth by means of a studded membrane (10) for underfloor heating, of the detaching membrane type which also acts as a support for the laying of electrical conductors, which consists of one waterproof plastic sheet (100) coupled to one base layer (110) for anchoring the membrane on the laying plane, with studs (100, 101a, 101b) protruding from the membrane-plane (104, 108, HI) and are arranged in a matrix with regular center to center distance in such a way to obtain hollow and continuous spaces among them in the form of corridors, and comprises retaining means suitable for retaining a heating cable (200) placed among the studs. In particular, said retaining means are adhesive curbs (106, L2, H2) made up of a glue laid in strips on the membrane-plane (104), in correspondence with said corridors among the studs acting as laying corridors (105) for said glue.

### Aims

In this way, through the considerable creative contribution the effect of which constitutes an immediate technical progress, several advantages are achieved.

A first aim is to realize a detaching and support membrane for the laying of electrical conductors which is extremely versatile, being suitable for heating cables of any diameter or for conductors of any shape and/or size. Basically, it is intended to realize an advantageous membrane for electrical underfloor heating which is compatible with all heating cables which are present on the market, like a universal solution suitable for solving the abovementioned practical problems of the installer and the designer. With the proposed solution, they are indeed no longer constrained to a specific conducting element or heating cable but they can choose each time the most suitable and efficient heating means according to the environment to be heated and/or to the project energy dimensioning and/or the availability of materials.

A second aim, directly linked to the first one, is to realize a detaching membrane provided with advantageous integrated retaining means, suitable for retaining said heating cable or any linear element of thermal and/or electrical conduction with greater freedom of execution and management. They do not conventionally act like a mechanical anchoring to the membrane as in D1-D4 where the cable is mechanically retained by interlocking and/or engaging by the protrusions or studs present on the membrane itself, constraining its size and conformation; the present invention indeed proposes an alternative solution for retaining the heating cable or conducting wire which is no longer determined by the exact distance between the studs and/or their conformation. In particular, an advantageous retaining means by adhesion is proposed, which is integrated on the external surface of the membrane in the hollow space between two protrusions placed side by side; in this way, the choice of said heating cable is rendered independent of a specific detaching membrane, dedicated to it, with greater freedom of application and management. Furthermore, greater design freedom is allowed in the realization of the membrane, since the studs can be of standardized shape and/or size or all the same, but they can also have different size and/or shapes, for example with round, oval and polygonal studs combined with each other in the same membrane, being completely independent of the innovative heating cable retaining system.

Consequently, the designer is given greater freedom in designing the passages of the heating cable; the single cable can be indeed laid in a parallel or orthogonal way with respect to the alignment axes of the protrusions, but also in an oblique or diagonal direction; with the proposed solution, the engaging arrangement is indeed independent of a specific punctual retaining means, having a specific engagement and/or insertion conformation, since the adhesive means which ensures the retaining is independent of a certain engaging orientation and/or alignment and/or positioning.

A third aim is to realize a structurally simplified detaching membrane, with studs without undercuts and/or lateral protrusions acting as retaining means for both the heating cable and the cement mortar, but which is however capable of increasing said tear resistance by improving the adhesion of a layer of glue and/or cement mortar which is superimposed on the membrane in order to complete the flooring. The proposed solution has studs of simplified conformation, which do not act as a retainer for the heating cable or the cement mortar, but it integrates alternative retaining means which render at the same time the membrane independent of a diameter and/or a predefined conformation of the heating cable, and they are also able to increase the adhesion of the cement mortar superimposed on it.

A fourth aim consists in realizing a detaching membrane with adhesive retaining means which do not hinder the normal laying operations, being joined to the membrane between the studs so as not to stick to the surfaces of the objects and/or to the materials it can accidentally contact during the activities of transport or installation on site. Therefore, adhesive means integrated into the membrane are made available which do not hinder or slow down the operations of the installer, facilitating on the whole the installation of an underfloor heating system with heating cable.

A fourth aim is to realize a detaching membrane provided with said adhesive and advantageously elastic retaining means, adapted for repositioning or with reversibility of laying, so as to retain the heating cable once it is laid but also so as to be able to remove it and reattach it several times where it is necessary to modify and/or adapt the path of the heating cable with respect to the initial project, or consequently to a laying error.

A fifth aim is to realize a detaching membrane which is provided with effective and innovative retaining means for said heating cable, according to the various aims set out above, and which has a simplified structure of the plastic sheet with studs without undercuts and/or mechanical engaging means, considerably facilitating production with respect to said known solutions referred to in D1-D4. In particular, the adoption is allowed of automated production equipment with high production volumes and low cost.

These and other advantages will be evident from the following detailed description of some preferred embodiments with the aid of the enclosed schematic drawings whose execution details are not to be intended as limiting but only exemplary.

### BRIEF DESCRIPTION OF THE SEVERAL VIEWS OF THE DRAWINGS

FIG. 1 schematically represents from above a portion of the studded membrane for underfloor heating, which is the subject matter of the present invention; the dashed rectangle delimits a modular portion of the membrane which includes four cylindrical studs placed side by side, for example of the type with a lowered head in the form of an introflexed cavity, and is particularly equipped with an adhesive curb integrated between the studs on the membrane-plane with the aim to retain a heating cable.

FIG. 2 is a section relative to the section plane X-X of FIG. 1; said membrane consists of a plastic sheet with studs arranged at a regular center to center distance, represented with a continuous line, which is coupled on the lower face to a base layer in non-woven fabric or TNT, schematically represented with a dashed line and spaced apart to facilitate the understanding; the heating cable retained by the adhesive curb is schematically represented in section with a continuous line circle.

FIG. 3 is an enlarged detail of the previous section, where the dimensional characteristics of the curb are indicated with respect to the space between adjacent studs or laying corridor.

FIG. 4 represents a variant of the invention shown in FIG. 1, where the same adhesive curb is also integrated between circular studs of differentiated diameter and conformation by pairs, obtaining a wider and more irregular laying corridor which allows greater freedom of laying of the heating cable.

FIGS. 5, 6 and 7 illustrate advantageous examples of integration of said adhesive curb, according to the present invention, where the membrane is schematically represented with a modular portion thereof including twelve cylindrical studs arranged at a regular center to center distance. FIG. 5 is a first example where the adhesive curb is integrated into each laying corridor, in both directions, like an orthogonal adhesive mesh; FIG. 6 and FIG. 7, are instead examples of integration of the adhesive curb in one direction only, or with parallel curbs, respectively in each corridor or in alternating corridors.

### DETAILED DESCRIPTION OF THE INVENTION

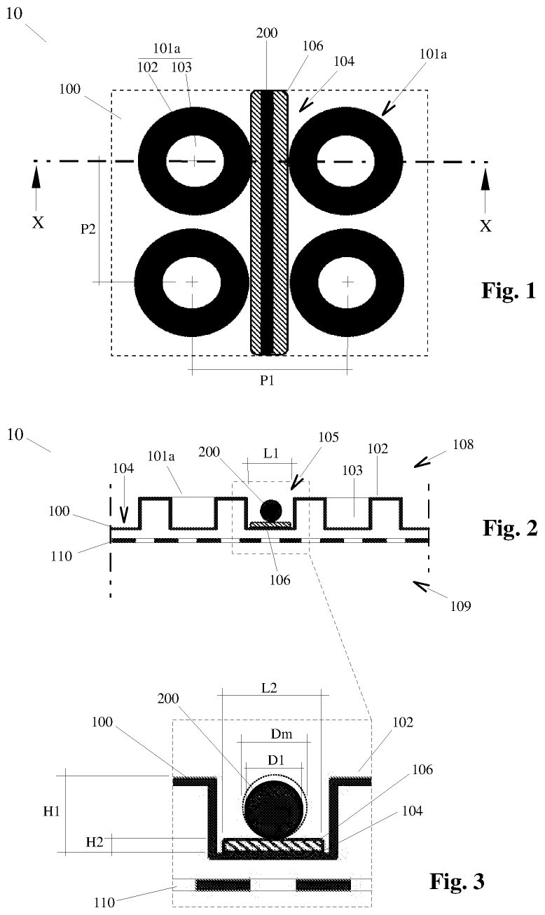

With reference also to the figures (FIGS. 1-7), a studded membrane (10) for building of the detaching type is proposed, which is advantageously provided with retaining means for positioning and retaining the heating cable when laying an underfloor heating, also called electric radiant floor. In particular, the described membrane has a simplified structure and retaining means which are advantageous with respect to the known solutions where the retaining means are of the mechanical type being obtained and/or integrated in the conformation itself of the studs and/or in their arrangement, like multiple punctual engaging and/or interlocking elements. In the solution proposed by the present invention, the function of retaining the heating cable (200) is instead performed by an innovative adhesive curb (106) which is included between stud and stud (101a, 101b), in adhesion to the membrane-plane (104); the studs are thus completely independent of the abovementioned mechanical retaining function and can be thus freely shaped and arranged, without pinches and/or undercuts and/or dimensional constraints. It is then noted that in the proposed membrane there is no mechanical engaging means integrated or inserted, since said retaining means have an exclusively adhesive action so that the choice of the diameter and/or the conformation of the heating cable, or any conductive heating element, is completely independent of the conformation and/or arrangement of the protrusions or studs of the membrane, allowing greater freedom of choice and versatility of application.

A very versatile and economical studded membrane (10) for underfloor heating is thus made available, which has a stratified structure of the type widely known in the sector of detaching membranes, being composed of one upper layer consisting of one studded and waterproof plastic sheet (100, 108), and of one base layer (110) which is coupled to it on the lower side (109) for anchoring the membrane on a laying plane. For example, this anchoring takes place by spreading a layer of glue or cement mortar directly on a concrete screed or any flat bearing element. In addition to said detaching or separating function, the proposed membrane (10) also acts as a support for an electrical heating cable (200), or an equivalent heat conductive element in the form of wire, pipe, cable or tape, where all the studs or protrusions (101a, 101b) of the plastic sheet (100) have a conventional conformation, for example having a cylindrical shape with smooth and regular walls, that is, being simplified with respect to the membranes having the same function since the means predisposed to retain said cable (200) are independent of said studs or protrusions (101a, 101b) so as to facilitate the laying and simultaneously achieve the abovementioned aims.

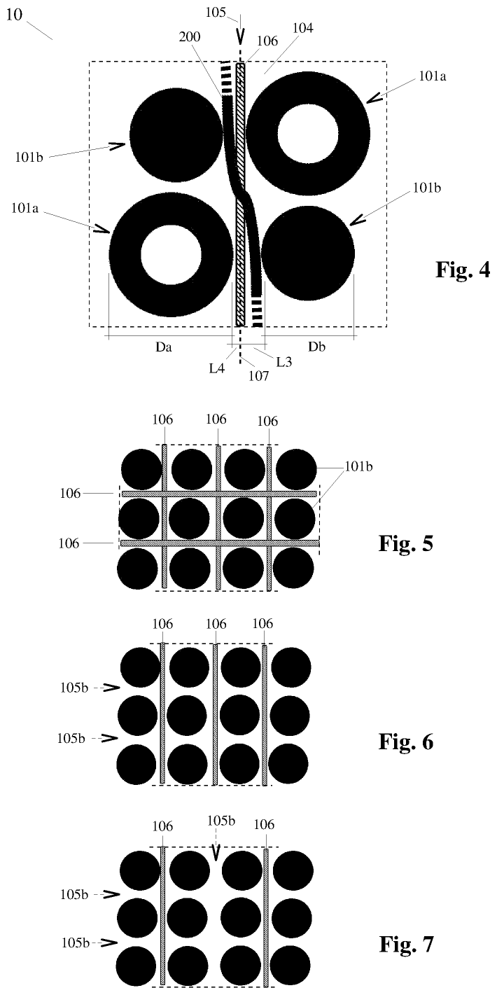

More in the realization detail, said studded sheet (100) is made up of an extruded plastic material having a thin thickness; polyolefins, polyester and polyamide are suitable for the invention, where in the preferred embodiment use is made of a polyolefin such as polypropylene or polyethylene or of a mixture between them or also of a mixture modified with EVA or TPO. This plastic sheet (100) includes studs (101a, 101b) which protrude upwards (108, HI) and are arranged in a matrix with a regular pitch or with the center to center distances (PI, P2) aligned in such a way as to obtain hollow and continuous spaces between them like corridors or channels (105, LI) where said adhesive curb (106, L2) can be laid in adhesion to the membrane-plane (104). As a mere example, these studs have a regular cylindrical or slightly truncated cone shape, and have two different construction conformations (101a, 101b, 103) which can be present only individually (FIGS. 1, 2, 5, 6, 7) or in combination with each other with alternate pitch (FIG. 4), as described below.

Said base layer (110) is instead an interface layer preferably made of a non-woven fabric, also known by the acronym TNT; for example, a TNT layer of polypropylene fibers, of the type called spunbonded or spunlace, is suitable for the invention. Alternatively, this layer (110) consists of a thin layer of glue acting as a self-adhesive film, joined to the surface of the studded membrane which contacts the floor in such a way as to anchor said membrane directly on said laying plane without cement gluing agents; the laying takes place after removing a protective plastic film which is externally coupled. Such a solution considerably facilitates the laying operations and is particularly suitable for the amateur building sector, also known as do-it-yourself. A further variant embodiment, not represented in the figures, involves the addition of a third metal layer between said studded sheet and said base layer, for example a thin aluminum sheet, where such metal layer reflects heat upwards (108) by irradiation and thus allows to increase the efficiency of the electric heating system with heating cable or equivalent radiant floor.

On the upper face of said membrane (10, 108), therefore, between said studs or protrusions (101a, 101b, PI, P2) channels are formed which are parallel and orthogonal with respect to each other called laying corridors (105), both in the longitudinal and transversal directions (FIGS. 1, 5, 6, 7). For the aims of the invention, in particular, a thermofusible glue which is pressure sensitive is advantageously laid in said corridors, or it is a glue of the type called hot-melt pressure-sensitive, and is characterized by a long open time; it is clarified that this technical characteristic of the glue is otherwise called evergreen. Furthermore, the involved glue is characterized by good compatibility both with the plastic surface of said sheet (100, 104) where it is laid, and with respect to the protective plastic coating which covers the conductor wire or the heating cable (200) of the underfloor heating. A glue is suitable for the invention based on ethylene-vinyl acetate copolymers or by acronym EVA, and/or polyolefins, and/or styrene-isoprene-styrene copolymers or by acronym SIS, and/or styrene-butadiene-styrene copolymers or by acronym SBS, and/or synthetic resins, and/or waxes, and/or paraffins, these materials being considered alternatively or in combination with each other. Furthermore, for this glue a material is suitable having a softening point higher than 70° C., and with a Brookfield viscosity greater than 2000 cPs when measured at 160° C.

The abovementioned glue is advantageously applied like a tape or bead, having a defined width (L2) and a defined thickness (H2), so as to form an adhesive curb (106) which is elastic; depending on a specific application of the membrane (10) or in order to limit the consumption of glue, it can be continuous and/or discontinuous, said glue being applicable with continuous delivery in parallel strips or in aligned segments and/or points, alternatively or in combination, by means of the industrial dispensing systems conventionally used for the laying of hot glue of the hot-melt type. It is noted that the glue used for this aim is elastoplastic and is deformable at the operating temperature, so that the adhesive curb (106) can be slightly crushed when the installer applies the electrical conductor or heating cable to it, placing it in adhesion with light pressure to activate adhesion. Moreover, thanks to the abovementioned evergreen characteristic, it allows the repositioning of the heating cable (200) in the event of error or design changes.

For the aims of the invention, it is clarified that the laying of said glue between the studs can take place by straight lines along said laying corridors but it can also occur by curved lines and/or wavy lines and/or in a zig zag pattern, these configurations being alternatives or in combination with each other. For example, an assimilated configuration indicates a configuration where straight segments are combined with curved sections, also to obtain dedicated paths.

In order to further facilitate the work of the installer, it is advantageous to provide adhesive curbs (106) made up of a colored glue, for example in a contrasting chromatic tone with respect to said plastic sheet (100), so as to highlight their presence.

It has then been found that the abovementioned glue of the adhesive curb (106) has good adhesion also to cement mortars and glues; this characteristic of the proposed membrane (10) allows to increase the tear resistance of a common flooring which is superimposed and glued on it.

More in detail about the plastic sheet (100), it is made of polyolefins or of the abovementioned materials suitable for the invention, with a thickness of between 0.5 mm and 2.5 mm, such as 0.75 mm for example; said studs (101a, 101b) protrude from the membrane-plane (104) for a height (HI) of between 3 mm and 25 mm, with the center to center distance among near studs (PI, P2) of between 6 mm and 52 mm. Between them, the laying corridors (105, LI) are then obtained for said glue, where it can be easily laid like continuous or discontinuous tapes, forming adhesive curbs (106) of consistent thickness being of between 0.1 mm and 3 mm, with a minimum width of a curb which is equal to 0.5 mm and a maximum width which is equal to the center to center distance (PI, P2) between the two studs which are opposite to each other frontally with respect to the laying corridor of the same curb. In the preferential configuration of the invention, said height (HI) is of between 5 mm and 10 mm so as to adapt to the diameter (Dl) of the most used heating cables (200) which have a diameter generally of between 3 mm and 8 mm considering the elastic wire with its covering sheath; in the case of a heated fluid radiant floor, a greater height (HI) is instead provided, that is between 8 mm and 25 mm, so as to easily integrate therein the most used pipes on the market having a diameter generally of between 7 mm and 20 mm. It is clarified that the abovementioned dimensions (HI, Dl) are intended as a mere non-limiting example.

For the aims of the invention, it is noted that the only dimensional constraint of the proposed solution, where a heating cable (200) or pipe of conventional type with circular section (Dl) is used, is the maximum diameter (Dm) allowed, this corresponding to the height of the studs (HI) minus the thickness (H2) of the adhesive curb (106); the floor which is then superimposed with a bedding layer made of cement mortar or glue, has indeed to rest on the heads (102) of the studs and has not to crush said cable (200) or said pipe, which is housed and protected in the space between the studs below them (102, 105, HI) (FIG. 3).

The shape of the studs is thus substantially free and can be truncated cone, truncated pyramidal, cylindrical with a circular or elliptical base, or prismatic, and these volumes may possibly have cavities in the head of different shapes suitable for containing a portion of the cement glue or mortar which is spread over the membrane (10) when laying the floor. In a particularly advantageous configuration with the aim of the tear resistance of a floor superimposed on the membrane (10), the studs (101a) have a circular base (FIGS. 1, 2, 3), being cylindrical and/or truncated cone, with the head (102) equipped with a central cavity (103) introflexed in the form of a recess suitable for housing the gluing agent of the floor; alternatively (FIGS. 5, 6, 7) or in combination (FIG. 4) with them (101a), there are flat and regular head studs (101b).

In the case of a mixed or combined configuration (FIG. 4) with two different configurations of the studs (101a, 101b) aligned with a regular pitch, for example with studs (101a) having a greater diameter (Da) equipped with said cavity (103) together with other studs (101b) having a smaller diameter (Db) without said cavity, of equal height, where they (101a, 101b) are opposite and crossed with respect to a laying corridor (105), it is noted that the latter is not exactly rectilinear and therefore the laying center to center distance (107) of the adhesive curb (106) is not centered (L3, L4) with respect to the two closest and opposite studs, at the sides of said corridor, as they have different diameters (Da, Db). In this case, the adhesive curb can be applied in a rectilinear way providing a smaller width (L2) or, alternatively, increasing the center to center distance between the studs, also with greater freedom of execution for the installer.

Consequently, it is evident that said studs or protrusions of the sheet can be completely equal to each other in shape and/or size, but they can also have a different conformation, being for example round, oval, polygonal, larger or smaller, depending on a particular application of the membrane or type of flooring. In any case, it is evident that the proposed solution allows greater freedom of installation and greater versatility with respect to known and conventional membranes for underfloor heating, the conformation of the studs being independent of the diameter and/or of the conformation of the heating means; in particular, a studded membrane (10) is proposed where the heating cable (200) is constrained only to the membrane-plane (104), by means of said adhesive curb (106), and not to the studs.

The heating cable (200) can be laid in a parallel or orthogonal way with respect to the longitudinal and transversal axes of the studs (101a, 101b, 105, PI, P2), but also in an oblique direction and/or in a non-rectilinear way, as there is always a crossing point where an adhesive curb (106) ensures the engaging of said heating cable on the membrane plane (10, 104). This characteristic of the invention allows a high degree of design freedom in the passages and in the laying of said heating cable or any electric wire or heating means (FIGS. 4, 5, 6, 7).

The proposed solution offers high production versatility. The glue can be indeed applied in any longitudinal and transversal laying corridor (105), between stud and stud, forming a very dense adhesive grid (FIG. 5). Alternatively, in order to also limit its cost of application and for a greater production speed, said glue can be applied only in the longitudinal or only in the transversal direction, obtaining adhesive curbs (106) arranged as parallel strips on each corridor (105), in the same direction (FIG. 6); or an application is possible and advantageous with alternating corridors (FIG. 7), that is with a corridor including the adhesive curb (106) and one without it (105b), or one including it every two without it, and so on. In any case, there is always an adhesive curb (106) which retains the heating cable (200) during the laying, since the laying path of said cable is always of the outward-and-retum type, however crossing the two directions at various points of the path.

In conclusion, it has been experimentally observed that the use of the studded membrane (10) proposed by the invention facilitates the laying of a radiant floor; in particular, it has been found that it allows to significantly reduce laying times, overall costs and operator efforts when laying the electrical heating cable, along predefined paths. Furthermore, it has been found in practice that said studded membrane (10) can be industrially produced at low costs, in an automated way and with high production volumes.

### NOMENCLATURE

(10) studded membrane for underfloor heating, according to the present invention, provided with an adhesive curb for retaining the heating cable;
(100) plastic, studded and waterproof sheet;
(101a, 101b) single stud of the sheet, protruding from the upper face. By way of non-limiting example, it is cylindrical, in two different realization conformations: a first conformation (101a) with a greater diameter and a central cavity, and a second conformation (101b) with a smaller diameter and without said cavity;
(102) head of the stud;
(103) central cavity of the stud, introflexed in the form of a recess integrated in the head having a maximum depth corresponding to the membrane-plane;
(104) membrane-plane;
(105) laying corridor of the adhesive curb, on the membrane-plane, it can have said curb or be without it (105b);
(106) adhesive curb, made up of a glue or equivalent adhesive material, laid between the studs on the upper face of the membrane-plane;
(107) center to center distance for laying the adhesive curb;
(108) upper side, face turned upwards or towards the floor-side;
(109) lower side, face turned downwards or towards the screed-side;
(110) base layer, in a non-woven fabric or a self-adhesive film;
(200) heating cable for electrical underfloor heating, or equivalent thin hot fluid pipe;
(Da) diameter of the largest stud, having a configuration with a central cavity;
(Db) diameter of the smaller stud, having a configuration without a central cavity; (Dl) diameter of the heating cable represented in the figures;
(Dm) maximum diameter allowed for a heating cable, such as not to exceed the head of the stud in height;
(LI) width of the laying corridor, useful distance between adjacent and opposite studs for the purpose of the laying of an adhesive curb;
(L2) width of the adhesive curb, in the finished product;
(L3) distance of the laying center to center distance from the stud with smaller diameter;
(L4) distance of the laying center to center distance from the stud with the greater diameter;
(HI) height of the stud, from the membrane-plane to the head;
(H2) thickness of the adhesive curb;
(PI, P2) center to center distance between the studs, also called pitch, with regular mesh in two directions orthogonal to each other.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. A studded membrane for underfloor heating, comprising one waterproof plastic sheet and of one base layer which is coupled to it on the lower side for anchoring the membrane on a laying surface, wherein said sheet is made up of a thin extruded plastic material and comprises studs protruding upwardly from the membrane-plane and are arranged in a matrix with regular center to center distance, in such a way to obtain hollow and continuous spaces among them in the form of corridors; said studded membrane comprising retaining adhesive means suitable for retaining at least a heating cable or a pipe, placed among said studs on the top side; wherein said retaining means are adhesive curbs made up of a glue laid in strips exclusively on the membrane-plane, in correspondence with said corridors among the studs acting as laying corridors for said glue; and wherein each adhesive curb has a thickness of between 0.1 mm and 3 mm, and a width which is at the minimum of 0.5 mm and at the most equal to the center to center distance between opposite studs on the sides of its laying corridor; and wherein said studs are thicker than the adhesive curb and located at a useful distance higher than 0.5 mm; and wherein said glue of the adhesive curb is made up of an elastoplastic thermal fuse material of the hot melt type, sensitive to pressure and with a long open time, in such a way to retain in a removable way said heating cable placed in adhesion on it; and wherein said glue of the adhesive curb is made up of a material having a softening point higher than 70° C., and with a Brookfield viscosity greater than 2000 cPs measured at 160° C.

23. A studded membrane for underfloor heating, according to claim 22, wherein said glue of the adhesive curb is made up of a thermal fuse material based on ethylene-vinyl-acetate copolymers i.e. EVA, and/or polyolefins, and/or styrene-isoprene-styrene copolymers i.e. SIS, and/or styrene-butadiene-styrene copolymers i.e. SBS, and/or synthetic resins, and/or waxes, and/or paraffins, being the above-mentioned materials considered alternatively or in combination with each other.

24. A studded membrane for underfloor heating, according to claim 22, wherein said adhesive curbs are: continuous and/or discontinuous in aligned intervals and/or discontinuous in aligned points, as alternatives or in combination with each other.

25. A studded membrane for underfloor heating, according to claim 24, wherein said adhesive curbs (106) are: in straight lines and/or in curved lines and/or in wavy lines and/or in a zig zag pattern, as alternatives or in combination with each other.

26. A studded membrane for underfloor heating, according to claim 24, wherein said adhesive curbs are rectilinear and are present both on longitudinal and transversal laying corridors, in the form of an adhesive grid.

27. A studded membrane for underfloor heating, according to claim 24, wherein said adhesive curbs are rectilinear and are present only on longitudinal or transversal laying corridors, as parallel lines.

28. A studded membrane for underfloor heating, according to claim 24, wherein said adhesive curbs are rectilinear and are present on all the longitudinal and/or transverse laying corridors.

29. A studded membrane for underfloor heating, according to claim 22, wherein said adhesive curbs are made up of a colored glue, in such a way as to highlight its presence.

30. A studded membrane for underfloor heating, according to claim 22, wherein said plastic sheet is alternatively made up of: polyolefins, polyester or polyamide; said plastic sheet, having thickness of between 0.5 mm and 2.5 mm, with said studs protruding from the membrane-plane for a height of between 3 mm and 25 mm and having the distance between centers among near studs of between 6 mm and 52 mm.

31. A studded membrane for underfloor heating, according to claim 30, wherein said plastic sheet is made up of polypropylene and/or of polyethylene, alternatively or of a mixture with each other or of said mixture also modified with EVA and/or TPO.

32. A studded membrane for underfloor heating, according to claim 22, wherein said plastic sheet has a thickness equal to 0.75 mm, with a tolerance of +/−20%, and has said studs protruding from the membrane-plane for a height of between 5 mm and 10 mm, wherein the distance between centers among near studs is of between 20 mm and 32 mm and wherein the width of said laying corridor is of between 4 mm and 10 mm.

33. A studded membrane for underfloor heating, according to claim 22, wherein said adhesive curb has a width of between 1 mm and the width of said laying corridor.

34. A studded membrane for underfloor heating, according to claim 32, wherein said adhesive curb has a width of between 2 mm and 5 mm.

35. A studded membrane for underfloor heating, according to claim 22, wherein the studs of said plastic plate have truncated cone and/or truncated pyramidal and/or prismatic and/or cylindrical with circular base and/or elliptical shape, all identical to each other or, as an alternative, with different and/or combined shape and/or sizes and/or arrangement.

36. A studded membrane for underfloor heating, according to claim 22, wherein the studs of said plastic sheet have the head equipped with a central cavity introflexed in the form of a recess suitable for housing an adhesive mortar for floors and/or have regular and flat head.

37. A studded membrane for underfloor heating, according to claim 22, wherein said base layer is a non-woven fabric.

38. A studded membrane for underfloor heating, according to claim 22, wherein said base layer is a thin glue layer acting as self-adhesive film facing the bottom side, being joined to the surface of the studded membrane which contacts the floor, with a protective film that is externally coupled to it in a removable way.

39. A studded membrane for underfloor heating, according to claim 22, wherein between said plastic sheet and said base layer a metallic layer which reflects the heat of the heating cable upwardly is interposed.

40. A studded membrane for underfloor heating, according to claim 39, wherein said metallic layer is an aluminum sheet.
